(19) United States
(12) Patent Application Publication
(10) Pub. No.: US 2024/0419153 A1
(43) Pub. Date: Dec. 19, 2024

(54) SYSTEM FOR MONITORING AND CONTROL OF GRAIN HANDLING SYSTEMS

(71) Applicant: Sukup Manufacturing Co., Sheffield, IA (US)

(72) Inventors: Daniel Wayne Shrock, Raymondville, MO (US); Matthew Koch, Clear Lake, IA (US)

(21) Appl. No.: 18/732,790

(22) Filed: Jun. 4, 2024

Related U.S. Application Data
(60) Provisional application No. 63/507,840, filed on Jun. 13, 2023.
(60) Provisional application No. 63/607,859, filed on Dec. 8, 2023.

(51) Int. Cl. G05B 19/418

(52) U.S. Cl. CPC G05B 19/4184; G05B 19/41865; G05B 2219/31449

(57) ABSTRACT

A system is presented for monitoring grain handling systems at a grain handling site. The system includes a central control system and one or more intermediate control devices communicatively connected to the grain handling systems. The central control system is configured to provide a first user interface configured to facilitate creation of a process flow and programming of the intermediate control devices to operate in accordance with the process flow. In response to detecting an error in the process flow during operation, the central control system is configured to prompt the plurality of intermediate control devices to cause the set of the grain handling systems to perform a first set of actions indicated by the process flow if the error occurs before the grain handling systems and perform a second set of actions indicated by the process flow if the error occurs after the grain handling systems.

### REFERENCE TO RELATED PATENT APPLICATIONS

This patent application claims priority to U.S. Provisional Patent Application 63/507,840 filed on Jun. 13, 2023 and titled SYSTEM FOR MONITORING AND CONTROL OF GRAIN HANDLING SYSTEMS; and claims priority to U.S. Provisional Patent Application 63/607,859 filed on Dec. 8, 2023 and titled ADAPTIVE CONTROL SYSTEM FOR OPTIMIZATION OF GRAIN HANDLING SYSTEMS, all of which are hereby fully incorporated by reference herein in their entirety.

### FIELD OF THE DISCLOSURE

This disclosure relates to grain handling systems used in agriculture. More specifically and without limitation, this disclosure relates to monitoring and control systems for use with grain handling systems.

### OVERVIEW

Since the development of harvesting technology that is capable of separating desired grains from the surrounding chaff, new technologies have been developed to handle bulk quantities of grain. Some various grain handling systems that have been developed include but are not limited to, for example, technologies for storage of bulk grain, such as grain bins; and/or technologies for drying grain, such as grain dryers; technologies for loading, unloading and/or otherwise moving grain, such as grain conveyors (e.g., bucket elevators, drag chains, belt systems augers, and/or air systems), sweep systems, and/or grain levelers to name a few.

Some example grain dryers are described in U.S. Pat. No. 10,767,926 titled “MIXED-FLOW GRAIN DRYER WITH CROSS-FLOW VACUUM COOL HEAT RECOVERY SYSTEM” and issued Sep. 8, 2020, and U.S. patent application Ser. No. 16/990,257 titled “BRIDGE REDUCING MIXED-FLOW GRAIN DRYER WITH CROSS-FLOW VACUUM COOL HEAT RECOVERY SYSTEM”, filed on Aug. 22, 2020, and issued as U.S. Pat. No. 11,193,711 on Dec. 7, 2021, each of which is hereby fully incorporated by reference herein. Some example grain conveyors are described in U.S. patent application Ser. No. 17/194,413 titled “SINGLE DRIVE DUAL HOPPER CONVEYOR SYSTEM”, filed Mar. 8, 2021, and published as U.S. Patent Publication 2021/0284469 on Sep. 16, 2021, U.S. Patent Publication 2020/0196532 titled “AIR SYSTEM”, published Jun. 25, 2020, and U.S. patent application Ser. No. 16/997,333 titled “SWEEP SYSTEM FOR FULL ELEVATED FLOOR GRAIN BINS” filed Aug. 19, 2020, and published as U.S. Patent Publication 2021/0051856 on Feb. 25, 2021, each of which is hereby fully incorporated by reference herein. Some example grain bins are described in U.S. patent application Ser. No. 17/346,373 titled “SELF-OPENING AIRTIGHT ROOF VENT SYSTEM FOR GRAIN STORAGE DEVICES” filed Jun. 14, 2021, and published as U.S. Patent Publication 2021/0392820 on Dec. 23, 2021, and U.S. Pat. No. 10,407,935 titled “DOUBLE END STUD BOLT AND METHOD OF USE” and issued Sep. 10, 2019, each of which is hereby fully incorporated by reference herein.

For simplicity purposes, reference is made herein to grain. However, the disclosure is not intended to be limited to grain. Instead, the disclosure is intended to apply to corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other flowable material. As such, unless specifically stated otherwise, reference to grain is intended to include all forms of corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other material.

Many agricultural handling systems are prone to interrupted operation due to various faults that may occur in operation of grain handling system. As one example, due to inconsistency of grain characteristics such as in weight, size, moisture content, debris or fines content, and the like, grain is subject to clumping or clogging within grain handling systems.

This means that a grain handling system may be optimally performing one moment can be disabled the next. As another example, despite heavy duty construction, components of grain handling systems are subject to failure due to excessive load and runtimes experienced in processing large quantities of grain. As yet another example, a destination grain bin may become full or a source may be completely emptied.

Failure of grain handling systems is exacerbated in that typically several grain handling systems are operated concurrently in a chain with grain being continuously transferred from one system to the next. Moreover, failure occurring in one grain handling system can cause problems in other systems upstream or downstream (depending on the systems involved), which may lead to damage and/or loss of grain, backing up of systems, and/or damaging systems. Due to the large potential energy of the large amounts of grain and/or machinery, nearby workers may face bodily harm when failures occur. As such, grain handling systems require constant oversight to ensure they are operating properly and ensure appropriate actions are taken when failure occurs to prevent harm to nearby personal, mitigate further damages to equipment, and/or mitigate loss of the grain being processed.

Some grain handling sites employ automated control systems to perform a series of predetermined actions when failure of a grain handling system is detected. The appropriate actions to be taken may vary greatly depending on the type, capabilities, and setup of equipment employed. Due to the complex interoperation of different equipment, determining appropriate predetermined actions for every possible scenario can be challenging and daunting task. To handle such complexity, there are professional programmers who specialize in programing of grain handling equipment. Such programmers may be needed review and reprogram control systems whenever new equipment is added, replaced, and/or updated. The expense of such programing services can add significant expense to operation of grain handling equipment over the lifetime of such equipment.

Therefore, for all the reasons stated above, and the reasons stated below, there is a need in the art for an improved control system for grain handling systems.

Thus, it is a primary object of the disclosure to provide a control system for grain handling systems that improves upon the state of the art.

Another object of the disclosure is to provide a control system that facilitates easy setup and configuration of grain handling systems.

Yet another object of the disclosure is to provide a control system that facilitates setup and configuration of grain handling systems without manual programing.

Another object of the disclosure is to provide a control system for grain handling systems that is easy to use.

Yet another object of the disclosure is to provide a control system for grain handling systems that is scalable.

Another object of the disclosure is to provide a control system for grain handling systems that is adaptable.

Yet another object of the disclosure is to provide a control system for grain handling systems that is reliable.

Another object of the disclosure is to provide a control system for grain handling systems that can operate without an internet connection. Yet another object of the disclosure is to provide a control system for grain handling systems that is easy to manufacture.

Another object of the disclosure is to provide a control system for grain handling systems that is durable.

Yet another object of the disclosure is to provide a control system for grain handling systems that has a robust design.

Another object of the disclosure is to provide a control system for grain handling systems that is relatively inexpensive.

Yet another object of the disclosure is to provide a control system that is high quality.

Another object of the disclosure is to provide a control system that can be used with any grain handling system.

These and other objects, features, or advantages of the disclosure will become apparent from the specification, figures, and claims.

### SUMMARY OF THE DISCLOSURE

In one or more arrangements, a system for monitoring and control of grain handling systems is provided. In one or more arrangements, the system includes a central control system and one or more of intermediate control devices communicatively connected to the central control system. The intermediate control devices are also communicatively connected to the grain handling systems. The central control system is configured to provide a first user interface configured to facilitate creation of a process flow. In one or more arrangements, the process flow indicates: a set of the grain handling system to be used for handling grain in the process flow, an order in which the set of grain handling systems handle grain in the process flow, a set of error parameters indicating conditions for detecting when the error has occurred in the process flow, and a set of control parameters indicating actions to be performed in response to detecting an error in the process flow. The central control system is configured to monitor statuses of the set of the plurality of grain handling systems during operation of the process flow. In response to detecting an error in the process flow, the central control system is configured to prompt the plurality of intermediate control devices to cause the set of the grain handling systems to perform the set of actions indicated by the set of control parameters. In one or more arrangements, the set of control parameters include control parameters to be used when an error occurs before the grain handling systems in the process flow and control parameters to be used when an error occurs after the grain handling system in the process flow. In one or more arrangements, creation of the process flow with the user interface includes presenting a list of grain handling systems installed at the grain handling site; selecting one or more grain handling systems to be used in the process flow from the list of grain handling systems; selecting the set of error parameters; and selecting the set of control parameters.

### BRIEF DESCRIPTION OF THE DRAWINGS

FIG. 1 shows a diagram of a system for configuration and control of grain handling systems, in accordance with one or more arrangements; the view showing a central controller communicatively connected with an example set of grain handling systems via intermediate control devices.

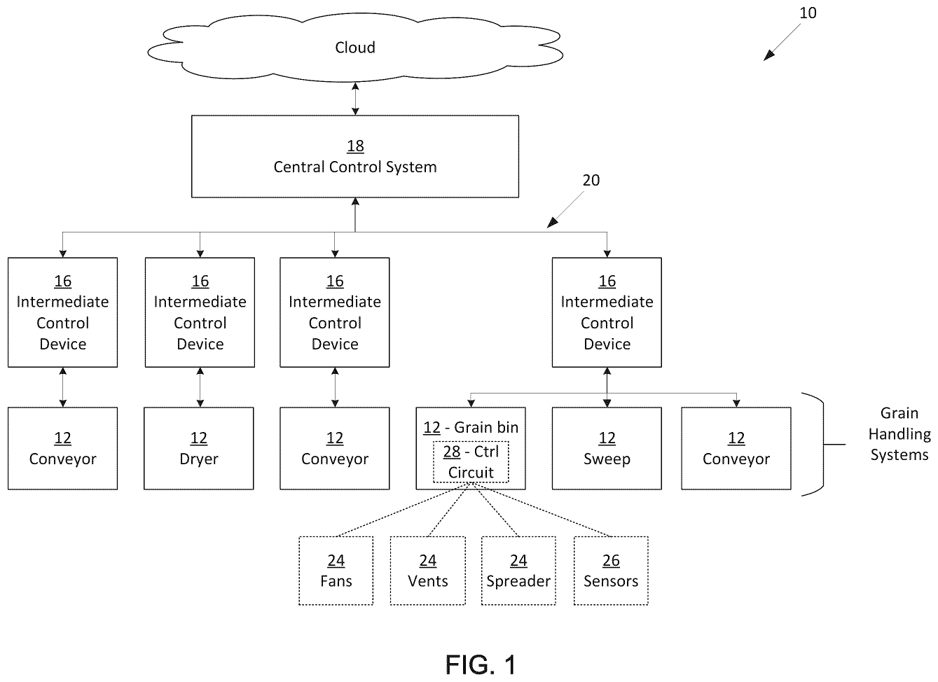

FIG. 2 shows a diagram of a system for configuration and control of grain handling systems, in accordance with one or more arrangements; the view showing a central controller communicatively connected with an example set of grain handling systems; the view showing the central controller configure to implement an example process flow.

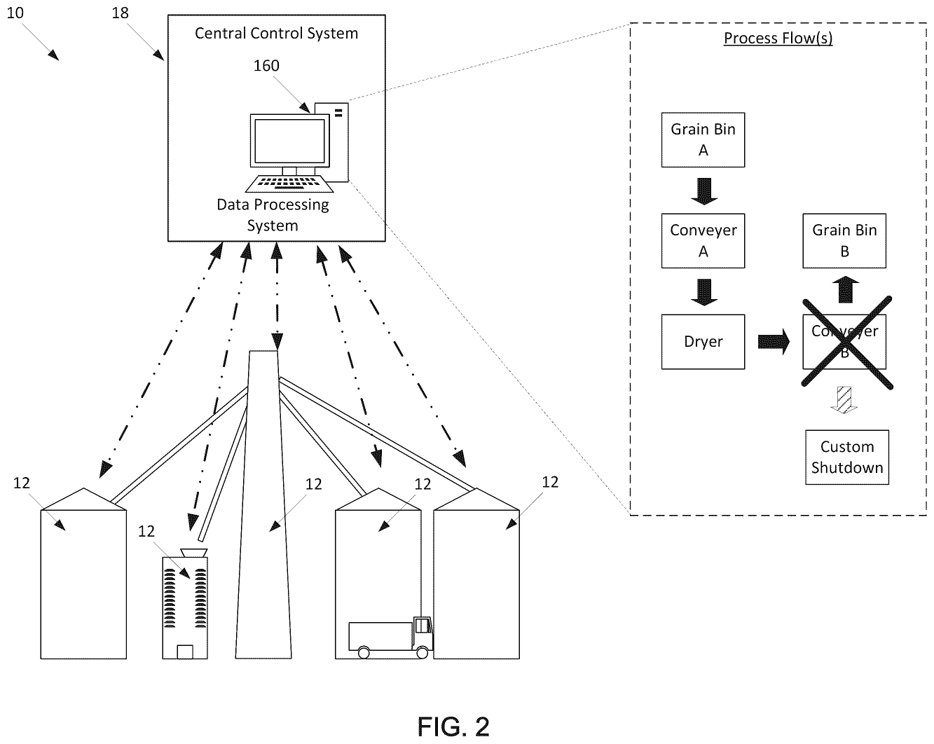

FIG. 3 shows an example process for installation and setup of an intermediate control device, in accordance with one or more arrangements.

FIG. 4 shows an example process for creation of a process flow, in accordance with one or more arrangements.

FIG. 5 shows an example process for monitoring and controlling grain handling systems according to a user created process flow, in accordance with one or more arrangements.

FIG. 6 shows a screen shot of an example user interface for a system for configuration and control of grain handling systems, in accordance with one or more arrangements; the view showing the user interface with a controllers & equipment dashboard displayed.

FIG. 7 shows a screen shot of an example user interface for a system for configuration and control of grain handling systems, in accordance with one or more arrangements; the view showing a process flow dashboard of the user interface configured to permit end users to create process flows for operation of select group of grain handling systems to perform desired tasks.

FIG. 8 shows a screen shot of an example user interface for a system for configuration and control of grain handling systems, in accordance with one or more arrangements; the view showing the process flow dashboard shown in FIG. 7 with information for an example process flow displayed.

FIG. 9 shows a screen shot of an example user interface for a system for configuration and control of grain handling systems, in accordance with one or more arrangements; the view showing the process flow dashboard shown in FIG. 7 with an interface window presented to facilitate creation of a new process flow.

FIG. 10 shows a screen shot of an example user interface for a system for configuration and control of grain handling systems, in accordance with one or more arrangements; the view showing the user interface as shown in FIG. 9 with an interface window presented to facilitate customization of error parameters for use with the process flow.

FIG. 11 shows a screen shot of an example user interface for a system for configuration and control of grain handling systems, in accordance with one or more arrangements; the view showing the user interface with interface window presented to facilitate customization of control parameters for use with a process flow.

FIG. 12 shows a screen shot of an example user interface for a system for configuration and control of grain handling systems, in accordance with one or more arrangements; the view showing the user interface with an example pop-up window presenting a warning that a particular control parameter is atypical and may lead to damage to equipment, loss of grain, or harm to workers.

FIG. 13 show a diagram of an example data processing system that may be used to implement systems, circuits, components, and/or processes of a central control system and/or intermediate control devices, in accordance with one or more arrangements.

FIG. 14 shows a screen shot of an example user interface to facilitate graphical arrangement of grain handling systems and/or other equipment as they are deployed on a site, in accordance with one or more arrangements.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of grain handling system. However, the embodiments are not so limited. It is appreciated that the embodiments may be adapted for use in other applications which may be improved by the disclosed structures, arrangements and/or methods. The system is merely shown and described as being used in the context of grain handling systems for ease of description and as one of countless example applications.

### System 10:

Turning now to the figures, a control system 10 (or simply system 10) is presented for configuration and control of grain handling systems 12, as is shown as one example. In the arrangement shown, as one example, control system 10 includes a central control system 18 and a set of intermediate control devices 16 communicatively connected with the central control system 18 (e.g., via one or more data networks 20) and with the grain handling systems 12, among other components.

### Grain Handling Systems 12:

Control system 10 may be used with various different grain handling systems 12 and arrangements thereof. Grain handling systems 12 are formed of any suitable size, shape and design, and are configured to facilitate loading/unloading of grain, transportation of grain, processing of grain, treatment of grain, storage of grain, evaluation/monitoring of grain, and/or or any other function related to handling of grain. As some illustrative examples, at some different grain handling sites, the various grain handling systems 12 may include but are not limited to, for example, grain pits, grain hoppers, grain conveyors (e.g., belt conveyors, drag chain conveyors, bucket conveyor, auger conveyors, and/or air system conveyors), grain dryers, grain bins, sweep systems, and/or any other type of grain handling system.

In one or more arrangements, as one example, a grain handling system 12 may include various equipment 24 (e.g., machinery, devices and/or other equipment), sensors 26, and/or control circuits 28, among other components.

### Controllable Equipment 24:

Equipment 24 is formed of any suitable size, shape and design, and is configured to perform a grain handling related function, involved in the processing and storage of grain from harvest to date of transportation from the grain handling site, that is operated by or controlled by an electronic signal. As some illustrative examples, in some arrangements, equipment 24 may include but is not limited to, for example, motorized or electronically actuated devices that may be operated by or controlled by electrical signals (e.g., vents, doors, sumps, augers, drag chains, spreaders, sweeps, fans, roof exhausters, heaters, lights, flow gates, leveling equipment, and/or any other grain handling related equipment).

### Sensors 26:

In some arrangements, one or more grain handling systems 12 include one or more sensors 26 to facilitate monitoring of grain condition, environmental factors, operation of equipment or any other factor or data metric relevant to the handling of grain. In some various arrangements, sensors 26 may include but are not limited to, for example, temperature sensors, humidity sensors, moisture sensors, pressure sensors, grain flow sensors, chemical sensors, optical sensors (e.g., cameras), motion sensors, light sensors, sound or vibration sensors, RF sensors, interlock switches, voltage and/or current sensors, positional sensors, geolocation sensors, and/or any other type of sensor. In some arrangements, sensors 26 may be formed along with control circuit 28 and/or equipment 24 a single combined component. Alternatively, in some arrangements, sensors 26 may be separated components from control circuit 28 and/or equipment 24.

### Control Circuit 28:

Control Circuit 28 is formed of any suitable size, shape, and design and is configured to control operation and/or configuration of equipment 24 in a grain handling system 12. Depending on the manufacture, types, and particular model, commercially available grain handling systems 12 may control circuits 28 with various different levels of features, capability, and/or interfaces for remote control by other devices and/or systems. In some grain handling systems 12, the control circuit 28 may provide sophisticated scheduling monitoring, and/or configuration and/or adjustment of operation. Conversely, in some grain handling systems 12, the control circuit 28 may comprise a simple on/off switch. Moreover, in grain handling systems 12 having a control circuit 28 that provides for control and/or configuration by other devices and/or systems, the control circuit 28 may be configured to communicate using any number of different standard or proprietary protocols and/or commands. Accordingly, interconnecting and coordinating control of the grain handling systems 12 can be a challenging and time consuming task.

### Intermediate Control Devices 16:

Intermediate control device 16 is formed of any suitable size, shape, and design and is configured to communicatively connect with central control system 18 and control circuits 28 of one or more grain handling systems 12 to facilitate control of the grain handling systems 12 as directed by and/or configured by central control system 18. In some various arrangements, intermediate control device 16 system 10 may be implemented using various different commercially available and/or custom-built controller circuits to control operation of grain handling systems 12.

### Central Control System 18:

Central control system 18 is formed of any suitable size, shape, and design and is configured to communicate with intermediate control devices 16 to facilitate installation and configuration and/or programming intermediate control devices 16 and/or grain handling systems 12 to operate grain handling systems 12 as desired by a user.

### Installation and Configuration:

In one or more arrangements, central control system 18 is configured to provide one or more user interfaces configured to facilitate the installation and configuration and/or programming intermediate control devices 16 and/or grain handling systems 12. In one or more arrangements, in response to user input, central control system 18 is configured to search and detect new intermediate control devices 16, facilitate selection of intermediate control devices 16, and facilitate selection of the grain handling system(s) 12 that will be controlled by the intermediate control devices 16. In one or more arrangements, central control system 18 is configured to automatically determine control/interface protocols for a selected intermediate control devices 16 and grain handling system(s) 12 and configure the intermediate control devices 16 to communicate with and operate the selected grain handling system with a default set of error handling behavior.

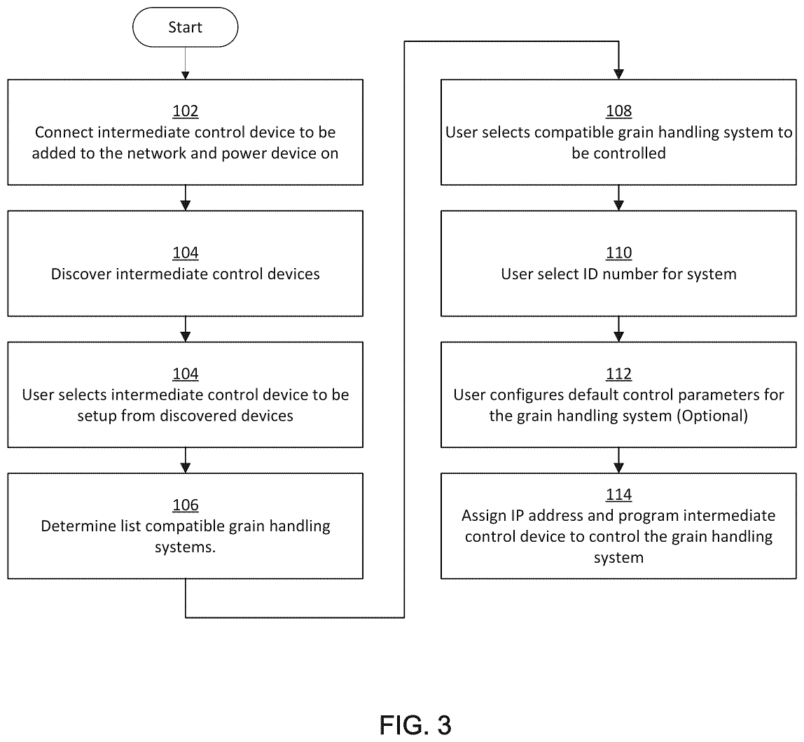

FIG. 3 shows an example process for installation and setup of an intermediate control device 16, in accordance with one or more arrangements. In this example, at process block 100 a user connects a new intermediate control device 16 to the network 20 and powers the intermediate control device 16 on. At process block 102, user prompts central control system 18 to discover new intermediate control device 16 on the network 20. In this example process, at process block 104, the user selects in intermediate control device 16 to be installed and/or setup from the discovered intermediate control devices 16. At process block 106, central control system 18 determines a list of grain handling systems 12 that are compatible with the selected intermediate control device 16. At process block 108, the user selects one or more compatible grain handling systems 12 that will be controlled by the selected intermediate control device 16. In this example process, the user selects an available ID number for the selected grain handling system(s) 12 that will be controlled by the selected intermediate control device 16. At process block 112, the user optionally may configure default control parameters and/or settings from the for the selected grain handling system(s) 12. In one or more arrangements, such default control parameters and/or settings may direct how the particular grain handling system(s) 12 operate and/or handle errors in absence of contrary configuration by an applicable process flow. In this example, at process block 114, central control system 18 automatically assigns an IP address to intermediate control device 16 and programs intermediate control device 16 to control the selected compatible grain handling systems 12 according to default configuration settings or any settings specified by the users at process block 112 (if any).

In some various different arrangements, programming of intermediate control device 16 by central control system 18 may include various different tasks or processes including but not limited to, for example: configuring intermediate control device 16 to communicate with the selected grain handling system(s) 12 (and/or control circuits 28 thereof) using the appropriate communication protocols and commands, configuring intermediate control device 16 with logic to monitor and/or control operation of the selected grain handling system(s) 12 in accordance with the set of default and/or user specified configuration and/or settings; testing of grain handling system(s) 12, control circuits 28, and/or intermediate control device 16 to verify correct configuration (e.g., verify user specified the correct grain handling system), and/or any other task or process that may be useful for configuration and/or setup of intermediate control device 16 and/or selected grain handling system(s).

However, the arrangements are not so limited to the example processes for installation and setup of an intermediate control device 16. Rather, it is contemplated that in some various arrangements, central control system 18 may be configured to implement various suitable additional or alternative processes to facilitate installation and setup of an intermediate control device 16.

### Process Flow Creation:

In one or more arrangements, central control system 18 is configured to provide one or more user interfaces configured to facilitate the creation of process flows to facilitate operation of a plurality of grain handling systems 12 controlled by installed intermediate control devices 16 in a desired sequence. In one or more arrangements, a process flows defines a set of grain handling systems 12 included in the process flow, the order in which the set of grain handling systems 12 are to process grain, a set of error parameters indicative of when an error has occurred in the process flow, and a set of actions to be taken when an error occurs in one of grain handling systems 12 in the process flow.

In one or more arrangements, the actions to be taken when an error is detected specify a first set of actions to be performed by a grain handling system 12 when the error occurs upstream of the grain handling system 12 in the process flow and a second set of actions to be performed by a grain handling system 12 when the error occurs downstream of the grain handling system 12 in the process flow.

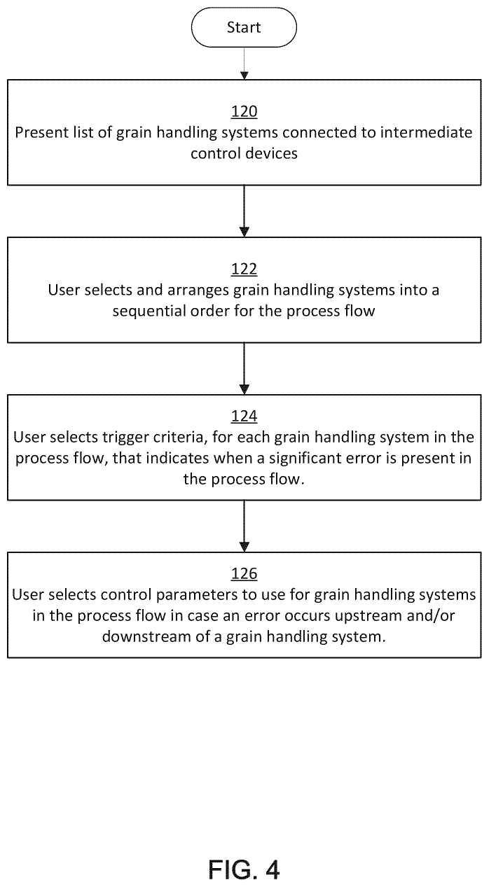

FIG. 4 shows an example process for creation of a process flow, in accordance with one or more arrangements. In this example, at process block 120, a user is presented with a list of grain handling systems 12 that the intermediate control devices 16 are configured to control. At process block 122, the user selects and arranges desired grain handling systems 12 from the list into a sequential order for the process flow. At process block 124, the user selects error parameters, for each grain handling system 12 in the process flow, that indicate when a significant error is present in the process flow. At process block 126, the user selects control parameters to use for the grain handling systems 12 in the process flow in case an error occurs upstream and/or downstream of the particular grain handling systems 12 in the process flow. Generally, grain handling systems 12 are configured with their own processes to perform when an error occurs within the grain handling system 12 itself. However, in one or more arrangements, adaptive control system 200 may permit a user to customize or specify (e.g., at process block 126) additional/alternative error handling processes for a grain handling system 12 to perform when an error occurs within the grain handling system itself. In one or more arrangements, when a process flow is created, the user selects error parameters (indicative of when an error has occurred) for each grain handling system 12 in the process flow. However, the arrangements are not so limited. Rather, it is contemplated that in one or more arrangements, central control system 18 may be configured to use default error detection criteria for a grain handling system 12 if none is specified by a user in the process flow.

Similarly, in one or more arrangements, when a process flow is created, the user selects control parameters (e.g., indicative of actions to be performed for upstream errors, downstream errors, and/or local errors) for each grain handling system 12 in the process flow. However, the arrangements are not so limited. Rather, it is contemplated that in one or more arrangements, central control system 18 may be configured to use default control parameters for a grain handling system 12 if none is specified by a user in the process flow.

In various different arrangements, central control system 18 may cause intermediate control devices 16 and/or grain handling system 12 to implement various different control parameters when errors occur depending on the type, arrangement, and configuration/settings of grain handling systems 12 for a particular process flow. Such control parameters may include but are not limited to, for example, immediate shutdown of a system, shutdown with cleanout, and/or continued operation of the system (e.g., potentially with or without adjustment of operation settings). However, the arrangements are not so limited. Rather, it is contemplated that in some arrangements, central control system 18 may permit a user to select from any number of different control parameters to direct operation when errors occur in a process flow.

In one or more arrangements, a user may additionally or alternatively specify non-default operation settings for grain handling system 12 when a process flow is created. Operation settings for some various grain handling systems 12 may include but are not limited to for example, operation speed, modes of operation, operating temperatures, operating pressure, duration of operation, start/stop times, or any other available setting on grain handling systems 12. In this manner, process flows may be created more easily since error handling criteria, error handling actions, and/or other non-default operation settings need only be specified if they are being customized by a user.

However, the arrangements are not so limited to the example processes for creation of process flows. Rather, it is contemplated that in some various arrangements, central control system 18 may be configured to implement various suitable additional or alternative processes to facilitate creation of process flows by a user.

For example, in one or more arrangements, central control system 18 may be configured to evaluate a process flow that has been created to identify if the process flow is operationally incorrect or unsafe. For example, in one or more arrangements, central control system 18 is configured to assess a process flow using a set of validation policies. Validation polices may be used for example to ensure process flow comply with certain principal operations. As one illustrative example, for safety reasons, administration for a site may set validation polices to ensure that pressing of any emergency shutdown button for any grain handling system 12 shuts down the entire process flow. As another illustrative example, as a default configuration, validation polices may ensure that no grain handling system 12 continues to move grain downstream when an error has occurred downstream. In some arrangements, central control system 18 may be configured to present a warning to a user if any validation policies are violated by a process flow. In some arrangements, central control system 18 may be configured to prevent such a process flow from executing until warnings are corrected. In some arrangements, central control system 18 may be additionally or alternatively configured to permit a user to review and override warning to permit the process flow to be executed. In some arrangements, central control system 18 may be configured to require approval by a site manager (or other authority) before warnings may be overridden.

However, the arrangements are not limited to the example processes for evaluating process flows. Rather, it is contemplated that in some various arrangements, central control system 18 may be configured to implement various suitable additional or alternative processes to evaluate process flows.

### Manual Checks by User:

In one or more arrangements, when a process flow is created a user may define manual checks to be verified by a worker at one or more location in a process flow prior to execution. When a process flow is to execute, central control system 18 may prompt a worker to perform and confirm manual checks included in the process flow prior to execution. As an illustrative example, in some arrangements, a workflow may be configured to prompt a worker to verify a grain bin door is properly closed and that the bin lid is open before executing a workflow that fills the grain bin. As another example, in some arrangements, a workflow may be configured to prompt a worker to verify that grain in a bin is the same as grain to be processed in the workflow to prevent different grains from being mixed. As another example, in some arrangements, a workflow may be configured to require a worker to look at a live image (e.g., taken by a camera inside a grain bin) and/or check the grain bin empty prior to starting a workflow that unloads the grain bin.

In some various different arrangements, central control system 18 may utilize various methods and means to prompt worker(s) to perform various checks and record conformation from the worker that the checks were completed. For example, in some arrangements, central control system 18 may provide a graphical user interface (e.g., via a smartphone app or web-portal) for a worker to select and initiate workflows and guide the worker through required checks and verifications. As another example, in some arrangements, central control system 18 may send a text message or email to a worker directing them to perform one or more checks and directing them to response with a particular message (e.g., CONFIRMED) to confirm that the check was performed. However, the arrangements are not so limited. Rather, it is contemplated that central control system 18 may be adapted to use any suitable method or means to verify that required checks are performed. Once required checks are performed, central control system 18 may cause grain handling systems 12 to start the workflow.

In addition to or in lieu of safety checks specified in a process flow, in one or more arrangements, safety checks may be specified for a particular grain handling system 12 (e.g., when the grain handling system 12 is connected to an intermediate control device 16 and configured. In one or more arrangements, if a safety check is configured for a grain handling system 12, the central control system 18 will required the safety check be performed before executing any process flow including the grain handling system 12, regardless of whether the process flow contains safety checks.

### Advance Warning System 170:

In one or more arrangements, system 10 includes an advance warning system 170. Advance warning system 170 is formed of any suitable size, shape, and design and is configured to provide advance warning to persons nearby grain handling systems 12 in a process flow prior to executing the process flow. For example, in one or more arrangements, advance warning system 170 includes one or more warning devices 172 (preferably one for each grain handling systems 12) that are controllable by central control system 18. In various some different arrangements, advance warning system 170 may include various different types of warning devices 172 including but not limited to, for example: visual warnings (e.g., rotating lights, flashing lights strobe lights, beacons, other lights, displays, actuated signs, or any other visual warning), audible warnings (bells, sirens, horns, buzzers, electric sounders, recorded messages, or any other audible warning), actuated gates or barriers, electronic messages (e.g., SMS text messaging, messaging apps, email, push notifications or other electronic communication), or any other type of warning device.

In one or more arrangements, advance warning system 170 includes one or more shutdown devices 174 to facilitate immediate shutdown of a process flow, for example by a nearby person when a warning device 172 is activated but the situation safe to operate the grain handling systems 12. In various some different arrangements, advance warning system 170 may include various different types of shutdown devices 174 including but not limited to, for example: buttons, leavers, switches, e-stops, interlocks, or any other means or method for a user to trigger shutdown of a grain handling system 12.

In one or more arrangements, central control system 18 is communicatively connected to shutdown devices 174 and is configured to immediately shutdown a grain handling system 12 associated one of the shutdown devices 174 when actuated. In one or more arrangements, central control system 18 may be configured to immediately shutdown all grain handling system 12 in a process flow when any one of the shutdown devices 174 for grain handling systems 12 in the process flow is actuated.

In one or more arrangements, system 10 may include multiple shutdown devices 174 for each grain handling systems 12, where one of the shutdown devices 174 causes central control system 18 to shutdown the associated grain handling systems 12 and the other one of the shutdown devices 174 causes central control system 18 to shut down all grain handling systems 12. The ability to shut down all grain handling systems 12 may provide faster shutdown times when an accident is observed by a worker located closer to another grain handling systems 12. That is, if an accident is observed, a worker may run to the closest grain handling system and engage the shutdown devices 174 set to shut down all grain handling systems 12.

### In Operation:

In one or more arrangements, central control system 18 is configured to permit users to create multiple different process flows that may then be loaded and executed as required to perform various different tasks that may be required in the production of grain.

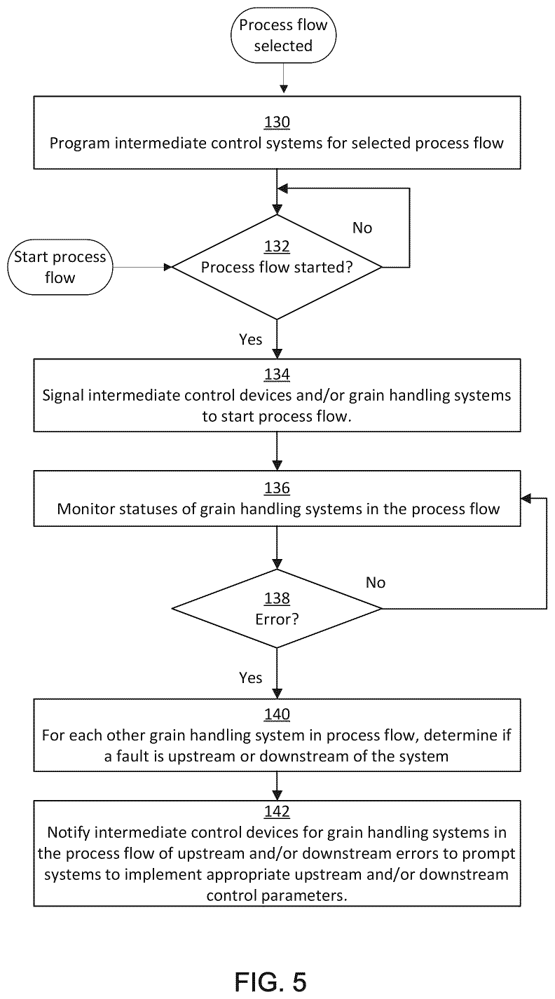

FIG. 5 shows an example process for monitoring and controlling grain handling systems 12 according to a user created process flow, in accordance with one or more arrangements. In this example, the process is initiated when a user selects a created process flow to load. At process block 130, intermediate control devices 16 for grain handling systems 12 in the selected process flow are programmed by central control system 18 to operate for grain handling systems 12 in accordance with configuration and/or settings of the process flow. In some arrangements, one or more grain handling systems 12 may additionally or alternatively be programmed at block 130 by intermediate control devices 16 and/or by central control system 18. In this example, after programming at process block 130, the process hangs at decision block 132 until a user starts the process flow. Once the process flow is initiated by the user, the process proceeds to process block 134. At process block 134, central control system 18 prompts intermediate control devices 16 and/or grain handling systems 12 to initiate the process flow. During normal operation of the process flow, central control system 18 monitors statuses of the grain handling systems in the process flow at process block 136.

If the monitored status indicates an error has occurred, at decision block 138, the process proceeds to process block 140. At process block 140, for each other grain handling system 12 in the process flow, central control system 18 determines if the error occurred upstream or downstream in the process flow. At process block 142, the central control system 18 notifies the intermediate control devices 16 for grain handling system 12 in the process flow of upstream and/or downstream errors (as applicable) to prompt the grain handling system 12 to implement the appropriate control parameters for upstream and/or downstream errors (e.g., as previously programmed for the process flow at process block 130). However, the arrangements are not so limited. Rather, it is contemplated that in some arrangements, central control system 18 may be configured to dynamically issue commands to intermediate control devices 16 and/or grain handling system 12 based on statuses of the systems rather than preprograming intermediate control devices 16 and/or grain handling system 12 (e.g., as performed at process block 130). Additionally or alternatively, in some arrangements, central control system 18 may be configured to preprogram intermediate control devices 16 and/or grain handling system 12 to implement control parameters independently but may also issue some commands to intermediate control devices 16 and/or grain handling system 12 dynamically during operation.

While some arrangements, may be primarily described with reference to central control system 18 indirectly monitoring, controlling, and/or communicating with grain handling systems 12 indirectly via intermediate control devices 16, the arrangements are not so limited. Rather, it is contemplated that in some arrangements, central control system 18 may be configured to communicate with and/or program one or more grain handling systems 12 without an intermediate control device 16 through one or more data networks.

### Not Limited to Mitigating Upstream/Downstream Errors:

For ease of explanation, some various arrangements may be described as determining appropriate control parameters based on whether error occurs upstream of, downstream of, or locally within each system. However, the arrangements are not so limited. Rather, it is contemplated that in some various arrangements, selection of control parameters for handling errors in a process flow may be based on any number of factors, sensor states, and/or logic functions.

Furthermore, while one or more arrangements may be primarily described with reference to implementing control parameters in response to errors specified by error parameters, the arrangements are not so limited. Rather, it is contemplated that error parameters may be used to specify states or situations that may not conventionally be considered errors. For example, a created process flow may define error parameters specifying sensor states/thresholds within a normal operating/process range. For example, in one or more arrangements error parameters may specify upper and lower thresholds for a temperature sensor in a grain bin to may be used indicate when grain temperature fall outside of a most preferred temperature range.

As another example, in some arrangements error parameters for a process flow may specify flow rates for one or more grain handling systems 12. Control parameters of the process flow may be configured to cause central control system 18 to adjust speed of one or more grain handling systems 12 according to flow rates specified by the error parameters to reduce the chances that grain handling systems 12 may become plugged and/or attempt to automatically unplug a plugged grain handling system 12.

### Illustrative Examples

Generally speaking, when a significant error occurs, in most situations it is generally desirable to immediately shutdown upstream grain handling systems 12, to pause flow of grain to the system in error, and continue to run downstream grain handling systems 12 for a cleanout period to move the downstream grain to the destination (e.g. grain bin, truck, etc.) unless an emergency stop is initiated. However, the preferred operations to perform in a process flow in response to errors can vary greatly between different grain handling sites depending on what equipment is used, what grain is being processed, what tasks are being performed in the process flow, and the particular priorities of the operator. There are any number of different situations that an operator may wish to operate grain handling systems 12 differently to address the needs and/or preferences of a particular grain handling site.

A one illustrative example, unless an emergency stop is initiated, in some grain handling sites, it may be desirable for certain types of upstream grain conveyors to continue running until cleanout is complete. For example, some bucket type grain conveyors are designed to be started up and running prior to being provided grain. If stopped while fully loaded, the motor of the bucket type grain conveyor may not have sufficient torque to restart operation without being overloaded. Similarly, if air type conveyors are stopped while grain is being transported, grain in the conveyor may fall down and may form a clog in the lower end of some conveyors. For such situations, an operator of a grain handling site may choose to configure control parameters of a process flow to stop an auger feeding the grain conveyor and continue operation of the grain conveyor for an unload period even if the next grain handling system 12 following the conveyor is full, disabled, and/or shutdown.

As another example, it may be desirable to shut down a downstream grain drier while it is still filled with dried grain inside so it may be more easily restarted as a later time. For instance, some grain dryers need to be filled with grain in order to control grain flow and drying conditions in the grain dryer. In such grain dryers, care is taken to ensure that the initial grain input while filling has been adequately dried to a shelf stable state for storage. Otherwise, if such grain retains too much moisture, there is risk they moist portion of grain may spoil and contaminate a large portion of grain in a grain bin. Accordingly, some grain dryers may have longer startup procedures to get to the state where they are filled with grain where the grain at the output of the grain dryer has been properly dried.

In such case, when an error occurs upstream of the grain dryer, the process flow may be configured to, for example, continue running grain handling systems 12 downstream of the error until sensors (e.g., at intake of the grain dryer) indicate that conveyors are no longer providing grain to the grain dryer. At such time, an auger conveyer that removes grain from the dryer may be shut down and the grain dryer may be switched to an orderly shutdown mode, where remaining grain in the dryer is dried in place for a period of time so it is shelf stable within the grain dryer. Such process flow may be useful for example when the harvesting process cannot maintain a constant flow of grain from a wet grain bin to the dryer.

### User Interfaces 36:

In one or more arrangements, central control system 18 is configured to provide one or more user interfaces configured to facilitate the installation and configuration and/or programming of intermediate control devices 16 and/or grain handling systems 12.

User interface 36 provided by central control system 18 may be formed of any suitable size, shape, and design, and/or technology and is configured to permit end users to interact with central control system 18 to facilitate input, access to, and processing of relevant data to facilitate installation and configuration and/or programming of intermediate control devices 16 and/or grain handling systems 12.

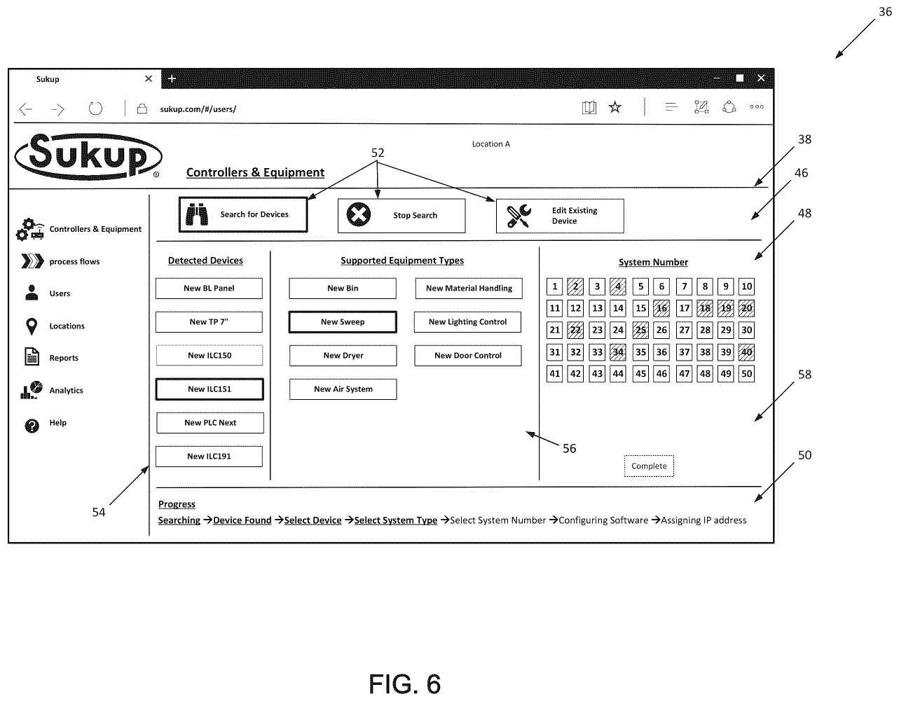

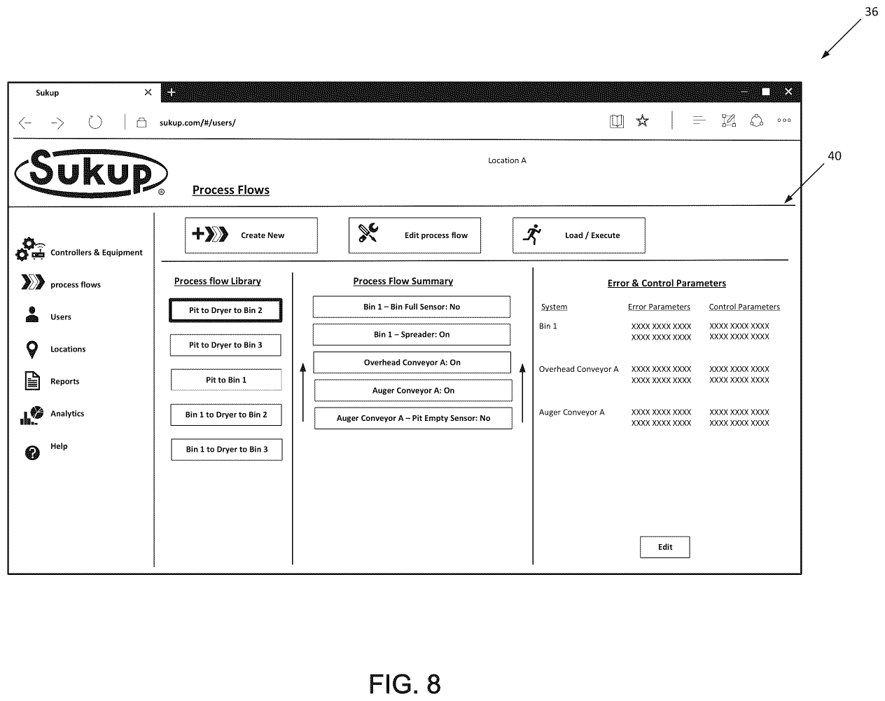

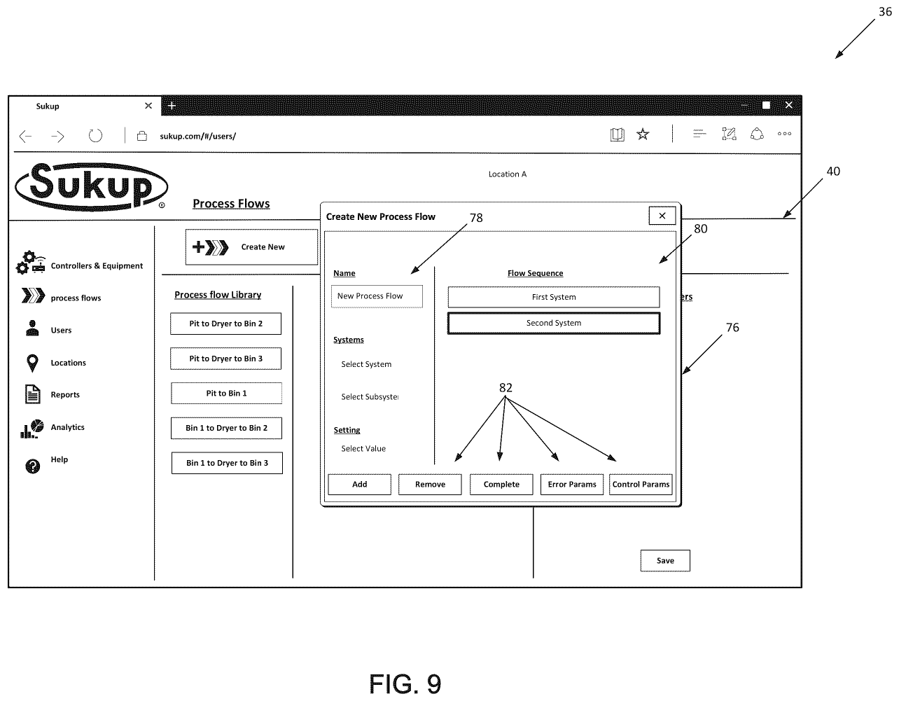

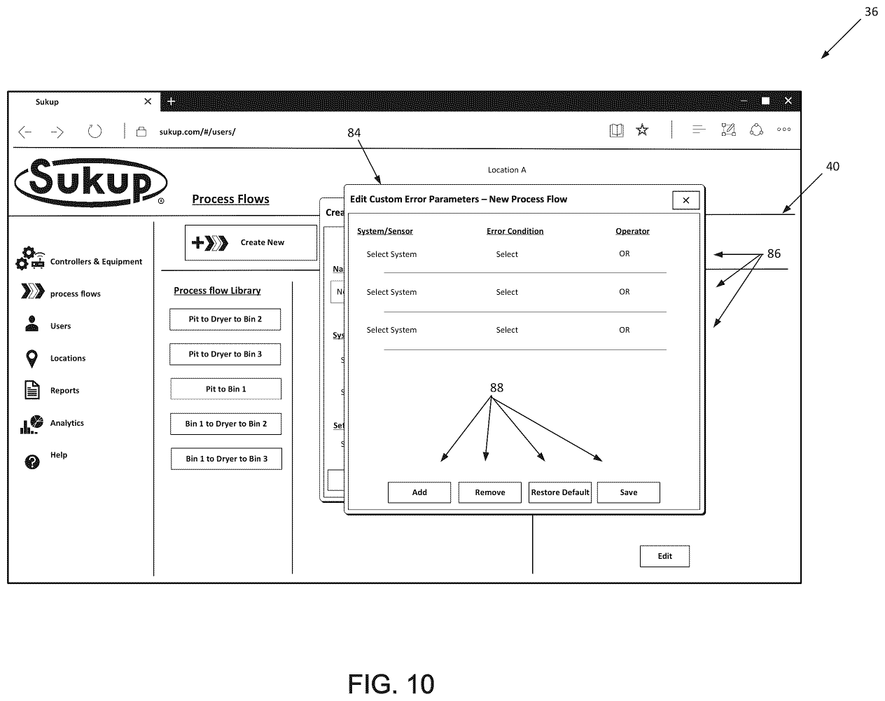

FIGS. 6-12 show screen shots of an example user interface 36, in accordance with one or more arrangements. In this example arrangement, the user interface 36 provides a controllers & equipment dashboard 38 and a process flow dashboard 40, among other dashboards and interfaces.

FIG. 6 shows a screen shot of the example user interface 36 with a controllers & equipment dashboard 38 (or simply dashboard 38) displayed. Dashboard 38 is formed of any suitable size, shape, and design, and/or technology and is configured to permit end users to facilitate installation and configuration and/or programming of intermediate control devices 16 and/or grain handling systems 12.

In this example application, the dashboard 38 includes an upper panel 46 having buttons 52 to facilitate searching for new devices (e.g., intermediate control devices 16) and/or configuring existing devices. In this example arrangement, after connecting a new device to the network, a user may use a “search for devices” button to initiate search for new devices. In this example, intermediate control devices 16 found in the search are listed in a left column 54 of a center panel 48. Upon a user selecting one of the intermediate control devices 16, compatible types and/or models of equipment that can be controlled by the selected intermediate control devices 16 are presented in a center column 56 of center panel 48. In this example arrangement, the user then selects the type/model of grain handling system 12 to be controlled in center column 56 and selects an identification number to assign to the selected system in a right column 58 of the center panel 48. In this example, identification number that have already been assigned are graphically distinguished from non-assigned numbers (e.g., by color or marking). After assigning the identification number to the system, the use may select complete to prompt the central control system 18 to configure software for and assign an IP address to the intermediate control device 16, among other tasks that may be required for installation. In this example arrangement, the dashboard 38 includes a lower panel 50 where progress of installation process is shown.

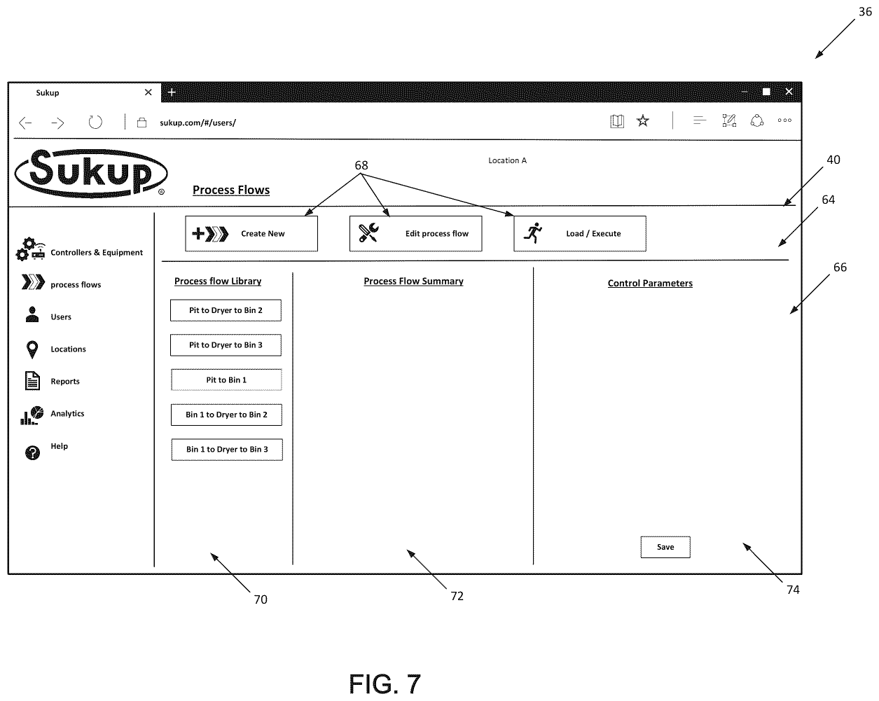

FIGS. 7-12 show screen shots of the example user interface 36 with process flow dashboard 40 (or simply dashboard 40) displayed. Dashboard 40 is formed of any suitable size, shape, and design, and/or technology and is configured to permit end users to create process flows for operation of select group of grain handling systems 12 to perform desired tasks.

In this example user interface 36, the dashboard 40 includes a lower panel 66 for display of process flows. In this example, a library of previously created process flows is listed in a left column 70 of lower panel 66. Upon a user selecting one of the process flows, a summary of the process flow is displayed in a center column 72 of lower panel 66. In this illustrative example, the process flow summary illustrates a sequence of grain handling systems 12 in the process flow and a high-level description of the intended operation of such systems in the process flow. In this example, lower panel 66 also includes a right column 74 configured to display a summary of error parameters (indicating criteria for detecting when errors occur) and control parameters (indicating actions to be performed by the grain handling systems 12 when errors occur) for the selected process flow.

In this example arrangement, the dashboard 40 includes an upper panel 64 having buttons 68 to facilitate creation of a new process flow, editing of a selected process flow, or loading and execution of a selected process flow.

In this example arrangement, when the user selects to create a new process flow, a separate interface window 76 is presented to facilitate creation of a new process flow. In this illustrative example, interface window 76 includes fields in a left column 78 to facilitate naming of the process flow and selection of systems and settings therefore to be added to the process flow. In this illustrative example, interface window 76 is configured to display a sequence of systems as added to the process flow in a right column 80. In this illustrative example, interface window 76 includes a number of control buttons 82 along a lower edge of the interface window 76 to facilitate addition of selected systems in left column 78 to the process flow, removal of systems from the current process flow, configuration of error parameters and/or control parameters for the systems in the process flow. In one or more arrangements, the software is configured to create the process flow using default error parameters and/or control parameters for the systems unless different error parameters and/or control parameters are set by the user.

In the example arrangement shown, if a user selects an “error parameters” button 82, a new interface window 84 is presented to facilitate customization of error parameters for use with the process flow. In this example, interface window 84 is configured to present selection fields for a user to define one or more sets of customized error parameters 86. In this example, interface window 84 is includes drop down interfaces in each set of error parameters 86 to facilitate selection of a system or sensor and a condition of the selected system/sensor that is indicated of error. In this example, a user may define several sets of error parameters 86 and specify logical operators (e.g., and/or) to connect the sets of sets of error parameters 86 into a logic function indicative of when an error has occurred. In this example, a user may add or remove sets of error parameters 86 using buttons 88 positioned at a lower edge of interface window 84.

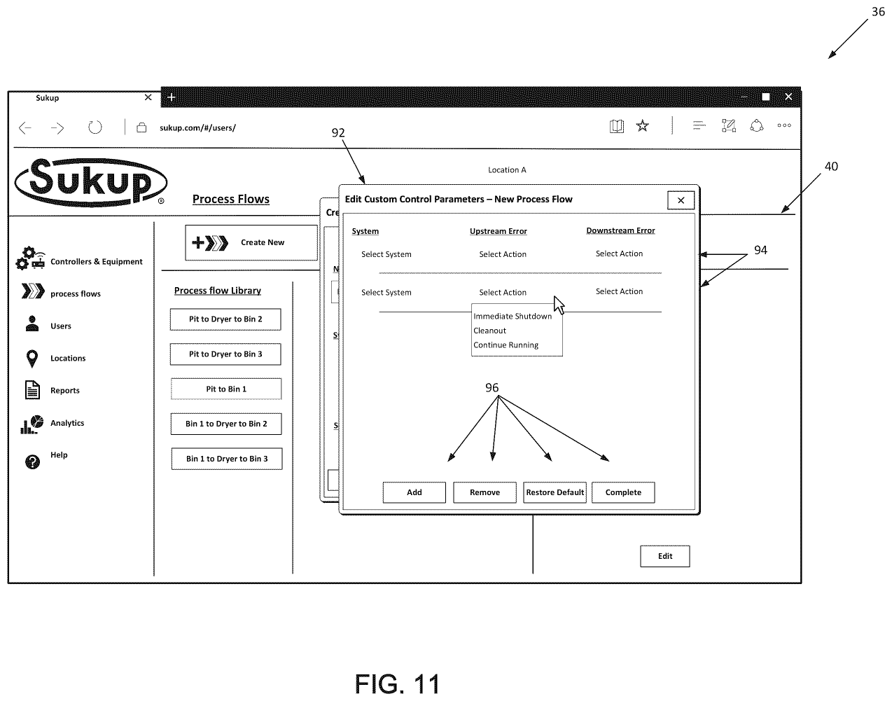

Referring back to the interface window 76 for creation of process flow, in this example, if a user selects “control parameters” button 82, a new interface window 92 is presented to facilitate customization of control parameters for use with the process flow. FIG. 11 shows such an example interface window 92, in accordance with one or more arrangements. In this example, interface window 92 is configured to present selection fields for a user to define one or more sets of customized control parameters 94. In this example, a user may add or remove sets of control parameters 94 using buttons 96 positioned at a lower edge of interface window 92. In this example, interface window 92 is includes drop down interfaces in each set of control parameters 94 to facilitate selection of a system, selection of an action to be performed if error occurs upstream of the system in the process flow, and selection of an action to be performed if error occurs downstream of the system in the process flow. In this example, the interface window 92 is configured to permit a user to select as a desired action 1) for immediate shutdown of the system, 2) for the system to run for a period of time to cleanout grain from the system, or 3) for the system to continue running. However, the arrangements are not so limited. Rather, it is contemplated that in some various arrangements, central control system 18 may permit users to select desired actions from various additional or alternative actions. Moreover, it is contemplated that in some various arrangements, central control system 18 may permit users to specify custom actions to be performed in response to upstream errors and/or downstream errors.

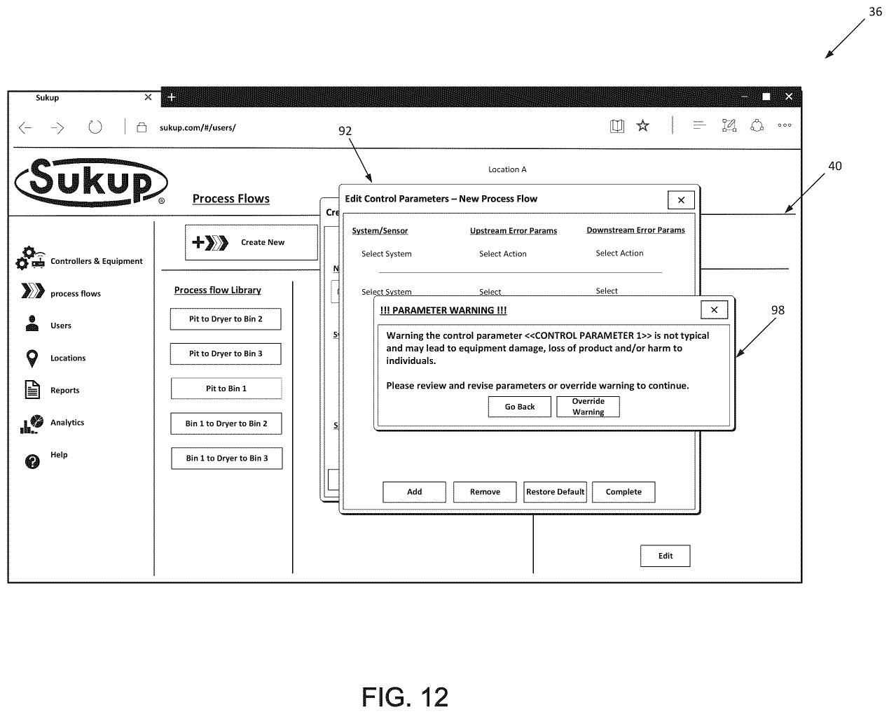

In one or more arrangements, central control system 18 is configured to evaluate control parameters once completed by a user to help ensure that the specified control parameters will not result in additional damage to equipment, loss of grain, or harm to workers. In one or more arrangements, user interface 36 is configured to present a pop-up window 98 with a warning if central control system 18 determines that the control parameters may result in additional damage to equipment, loss of grain, or harm to workers. FIG. 12 shows an example pop-up window 98 that may be presented in one or more arrangements. In this illustrative example, the pop-up window 98 presents a warning that a particular control parameter is atypical and may lead to damage to equipment, loss of grain, or harm to workers. In this illustrative example, the pop-up window 98 prompt the user to go back and review and correct the identified control parameter or to override the warning to proceed with the identified control parameter as is.

However, the arrangements are not so limited to the example user interfaces 36 discussed herein. Rather, it is contemplated that in various arrangements, user interfaces 36 may include any number of different dashboards and/or interface windows with various additional or alternative information in various different arrangements and/or having various additional or alternative means or methods for user selection and/or interaction.

### Custom Site Builder:

In one or more arrangements, user interfaces 36 includes a custom site builder tool 180 to facilitate graphical arrangement of grain handling systems 12 and/or other equipment as they are deployed on site. Such graphical arrangement may provide easy reference for selection of grain handling systems 12 (e.g., when creating process flows) in comparison to relying on naming convention to identify different grain handling systems.

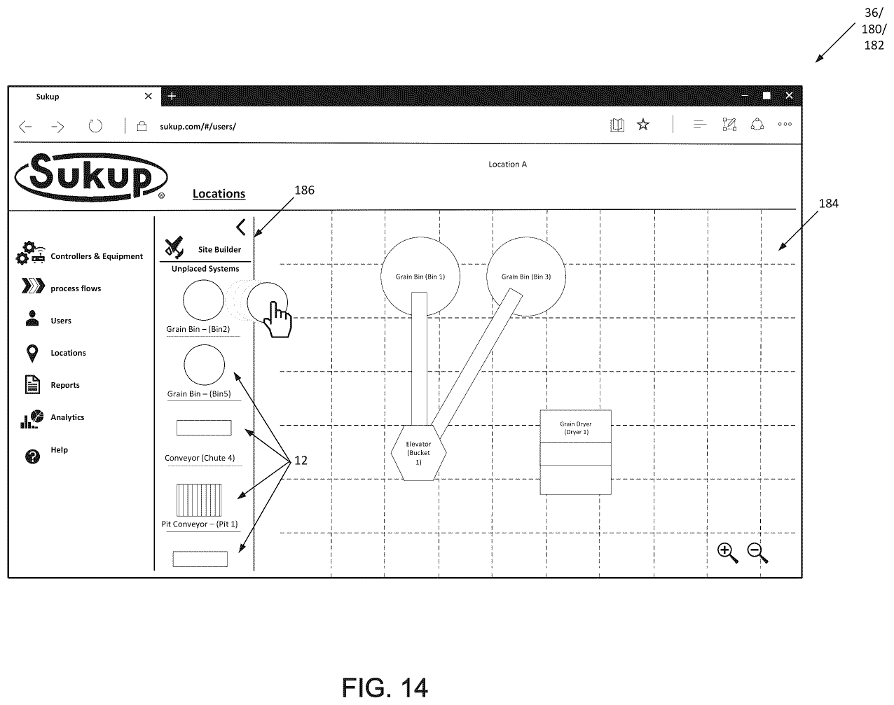

FIG. 14 shows an example interface providing custom site builder tool 180, in accordance with one or more arrangements. In this example arrangement, custom site builder tool 180 includes a main panel 184 having a grid layout on which a user may place grain handling systems 12 that have been added in the system 10. In this example arrangement, custom site builder tool 180 includes a side panel 186 having a scrollable list of grain handling systems 12 that have been added but have not been placed on the grid layout in main panel 184. In this example arrangement, a user may simply drag and drop grain handling systems 12 from side panel 186 to the grid layout in main panel 184. Once placed, a user may resize and/or customize the grain handling system 12 (e.g., by right clicking on the grain handling system 12 to view available options and/or actions). In this manner, a user may easily create and configured a layout of a site.

However, the arrangements are not so limited. Rather, it is contemplated that in some various different arrangements custom site builder tool 180 may utilize various means and/or methods to facilitate creation of a layout of the grain handling systems 12 on a site.

### Data Processing System 160:

Various blocks, modules, or other circuits may be used to implement central control system 18, intermediate control devices 16, or other components, operations and activities described herein and/or shown in the figures. In these contexts, a “block” (also sometimes “logic circuit,” “control circuit,” “processing circuit,” “server,” “module,” “data processing system” or “system”) is a circuit specifically configured and arranged to carry out one or more of these or related operations/activities. For example, such circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

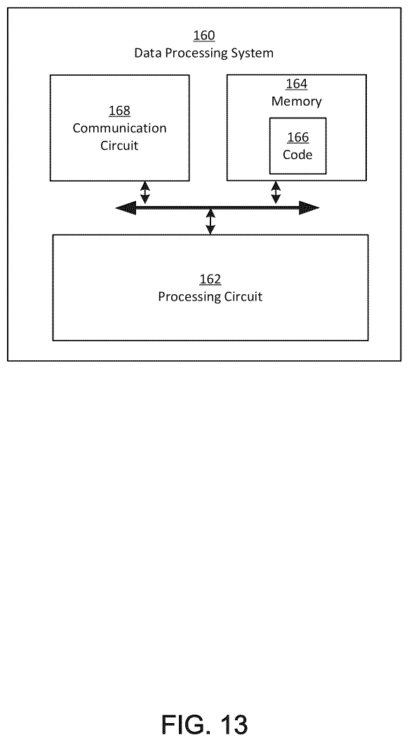

FIG. 13 shows an example data processing system 160 that may be used to implement systems, circuits, components, and/or processes of central control system 18 and/or intermediate control devices 16, in accordance with one or more arrangements. Data processing system 160 is formed of any suitable size, shape, design, and/or technology and is configured to carry out the one or more of these or related operations/activities described herein. In the arrangement shown, as one example, data processing system 160 includes a processing circuit 162 and memory 164 having software code 166 or instructions that facilitates the processing and/or display of information, and a communication circuit 168, among other components.

Processing circuit 162 may be any computing device that receives and processes information and outputs commands according to software code 166 or instructions stored in memory 164. Memory 164 may be any form of information storage such as flash memory, ram memory, dram memory, a hard drive, or any other form of memory. Processing circuit 162 and memory 164 may be formed of a single combined unit. Alternatively, processing circuit 162 and memory 164 may be formed of separate but electrically connected components. Alternatively, processing circuit 162 and memory 164 may each be formed of multiple separate but electrically connected components.

Software code 166 or instructions is any form of information or rules that direct processing circuit 162 how to receive, interpret, and respond to information to operate as described herein. Software code 166 or instructions is stored in memory 164 and accessible to processing circuit 162. As an illustrative example, in one or more arrangements, software code or instructions may configure processing circuit 162 to interact with users via a user interface and perform various processes in response to user input.

Communication circuit 168 is formed of any suitable size, shape, design, and/or technology and is configured to facilitate communication with various other components of system 10 (as may be applicable). In one or more arrangements, as one example, communication circuit 168 includes a transceiver circuit and an antenna. A transceiver is any electronic device that facilitates two-way communication, that is, the delivery of information between data processing system 160 and other components of the system 10. An antenna is any device that is configured to receive wireless signals from over-the-air communication and/or transmit wireless signals in over-the-air communication. In an example arrangement, a transceiver of communication circuit 168 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 168 may be configured to communicate over a wired communication channel.

In various arrangements, communication circuit 168 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of central control system 18, intermediate control devices 16, or other portions of system 10 may be primary described or shown as being implemented together on the same system, machine, network, program or process, the arrangements are not so limited. Rather it is contemplated that in some arrangements, such components, systems, programs, or processes of central control system 18, intermediate control devices 16 or other portions go system 10 may be implemented separately on by separate processes or programs and/or on separate circuits, systems, and/or components on the same bus or network or communicatively connected between different networks. Conversely, although in some arrangements, various circuits, components, systems, programs, or processes of central control system 18, intermediate control devices 16, or other portions of system 10 may be primary described or shown as being implemented separately, the arrangements are not so limited. Rather, it is contemplated that such components, systems, programs, or processes of central control system 18, intermediate control devices 16, and/or other portions of system 10 may be implemented together by the same processes or program and/or on the same circuit, system, and/or component of system 10.

From the above discussion it will be appreciated that the system 10 presented herein improves upon the state of the art. More specifically, and without limitation, it will be appreciated that in one or more arrangements, an improved control system for grain handling systems is provided: that improves upon the state of the art; that facilitates easy setup and configuration of grain handling systems; that facilitates setup and configuration of grain handling systems without manual programing; that is easy to use; that is scalable; that is adaptable; that is reliable; that can operate without an internet connection; that is easy to manufacture; that is durable; that has a robust design; that is relatively inexpensive; that is high quality; and/or that can be used with any grain handling system. These and other objects, features, or advantages of the disclosure will become apparent from the specification, figures, and claims.

It will be appreciated by those skilled in the art that other various modifications could be made to the device without parting from the spirit and scope of this disclosure. All such modifications and changes fall within the scope of the claims and are intended to be covered thereby.

### SELECTED REFERENCE NUMBERS

10—System
12—Grain Handling Systems
16—Intermediate Control Devices
18—Central Control System
20—Network
24—Equipment (of Grain Handling Systems 12)
26—Sensors (of Grain Handling Systems 12)
28—Control Circuits (of Grain Handling Systems 12)
36—User Interface
38—Controllers & Equipment Dashboard (of User Interface 36)
40—Process Flow Dashboard (of User Interface 36)
46—Upper Panel (of Dashboard 38)
48—Center Panel (of Dashboard 38)
50—Lower Panel (of Dashboard 38)
52—Buttons (of Upper Panel 46)
54—Left Column (of Center Panel 48)
56—Center Column (of Center Panel 48)
58—Right Column (of Center Panel 48)
64—Upper Panel (of Dashboard 40)
66—Lower Panel (of Dashboard 40)
68—Buttons (of Upper Panel 64)
70—Left Column (of Lower Panel 66)
72—Center Column (of Lower Panel 66)
74—Right Column (of Lower Panel 66)
76—Interface Window
78—Left Column (of Interface Window 76)
80—Right Column (of Interface Window 76)
82—Buttons (of Interface Window 76)
84—Interface Window
86—Sets of Parameters
88—Buttons
92—Interface Window
94—Sets of Control Parameters
96—Buttons
98—Pop up window
102—Process Block (of FIG. 3)
104—Process Block (of FIG. 3)
106—Process Block (of FIG. 3)
108—Process Block (of FIG. 3)
110—Process Block (of FIG. 3)
112—Process Block (of FIG. 3)
114—Process Block (of FIG. 3)
120—Process Block (of FIG. 4)
122—Process Block (of FIG. 4)
124—Process Block (of FIG. 4)
126—Process Block (of FIG. 4)
130—Process Block (of FIG. 5)
132—Decision Block (of FIG. 5)
134—Process Block (of FIG. 5)
136—Process Block (of FIG. 5)
138—Decision Block (of FIG. 5)
140—Process Block (of FIG. 5)
142—Process Block (of FIG. 5)
160—Data Processing System
162—Processing Circuit
164—Memory
166—Software/Code
168—Communication Circuit
170—Advance Warning System
172—Warning Devices
174—Shutdown Devices
180—Locations Dashboard (of User Interface 36)
182—Custom Site Builder Tool (of Locations Dashboard 180)
184—Main Panel (of Dashboard 38)
186—Side Panel (of Dashboard 38)

What is claimed:

1. A control system for a grain handling site, comprising:
a central control system;
the central control system configured to provide a first user interface;
wherein the first user interface is configured to facilitate the creation of a process flow;
wherein the creation of the process flow includes:
presenting a list of grain handling systems installed at the grain handling site;
selecting one or more grain handling systems to be used in the process flow from the list of grain handling systems; and
selecting a set of control parameters;
the set of control parameters including control parameters to be used when an error occurs before the grain handling systems in the process flow and control parameters to be used when an error occurs after the grain handling system in the process flow.

2. The system of claim 1, wherein the creation of the process flow further includes selecting a set of error parameters indicating conditions for detecting when the error has occurred in the process flow.

3. The system of claim 1, wherein the creation of the process flow further includes specifying a sequential order of the one or more grain handling in the process flow.

4. The system of claim 1, wherein the selected set of control parameters includes control parameters for each of the one or more grain handling systems.

5. The system of claim 1, wherein the selected set of control parameters includes for each of the one or more grain handling systems, control parameters indicating actions to be taken by the system when an error occurs upstream of the system in the process flow and control parameters indicating actions to be taken by the system when an error occurs downstream of the system in the process flow.

6. The system of claim 1, further comprising one or more intermediate control devices;
the one or more intermediate control devices communicatively connected with the central control system and the grain handling systems installed at the grain handling site;
wherein the central control system is configured to program the one or more intermediate control devices to operate the selected one or more grain handling systems in accordance with the created process flow.

7. The system of claim 1, further comprising one or more intermediate control devices;
the one or more intermediate control devices communicatively connected with the central control system and the grain handling systems installed at the grain handling site;
wherein the central control system is configured to provide a second user interface;
wherein the second user interface is configured to facilitate installation of the one or more intermediate control devices;
the one or more intermediate control devices communicatively connected with the central control system and the grain handling systems installed at the grain handling site;
wherein the central control system is configured to program the one or more intermediate control devices to operate the selected one or more grain handling systems in accordance with the created process flow.

8. The system of claim 1, wherein the central control system is configured to evaluate a process flow created using the first user interface to determine if the set of control parameters are likely to cause damage to equipment, loss of grain, or harm to workers if an error occurs.

9. The system of claim 1, wherein the central control system is configured to evaluate a process flow created using the first user interface and present a warning via the first user interface if the set of control parameters are likely to cause damage to equipment, loss of grain, or harm to workers if an error occurs.

10. The system of claim 1, wherein the selecting of the set of control parameters selects the set of control parameters from a set of control parameters comprising: immediate shutdown of a system, continuing to run the system for a cleanout time period followed by shutdown of the system, and continuing to run the system.

11. A control system for a plurality of grain handling systems, comprising:
a central control system;
a plurality of intermediate control devices;
the plurality of intermediate control devices communicatively connected to the central control system;
the plurality of intermediate control devices communicatively connected to the plurality of grain handling systems;
wherein the central control system is configured to provide a first user interface configured to facilitate creation of a process flow;
wherein the process flow indicates:
a set of grain handling systems of the plurality of grain handling systems to be used for handling grain in the process flow,
an order in which the set of grain handling systems handle grain in the process flow,
a set of error parameters indicating conditions for detecting when the error has occurred in the process flow, and
a set of control parameters indicating actions to be performed in response to detecting an error in the process flow;
wherein the central control system is configured to monitor statuses of the set of the plurality of grain handling systems during operation of the process flow;
wherein in response to the statuses indicating an error in the process flow, the central control system is configured to prompt the plurality of intermediate control devices to cause the set of the grain handling systems to perform a set of actions indicated by the set of control parameters.

12. The system of claim 11, wherein the central control system is configured to provide a second user interface configured to facilitate configuration of the plurality of intermediate control devices to control operation of the plurality of grain handling systems communicatively connected thereto.

13. The system of claim 11, wherein the central control system is configured to provide a second user interface configured to facilitate configuration of the plurality of intermediate control devices to operate of the plurality of grain handling systems communicatively connected thereto according to the process flow.

14. The system of claim 11, wherein the central control system is configured to provide a second user interface configured to facilitate configuration of the plurality of intermediate control devices to control operation of the plurality of grain handling systems communicatively connected thereto, by:
presenting a list of detected intermediate control devices;
a user selecting an intermediate control device from the list of intermediate control devices;
presenting a list of grain handling systems that are compatible with the selected intermediate control device;
the user selecting a grain handling system from the list that the selected intermediate control device is to control;
configuring the selected intermediate control device to control the selected grain handling system.

15. The system of claim 11, wherein for at least one system of the set of grain handling systems, the set of control parameters indicated by the process flow specifies:
a first action to be performed if an error has occurred upstream of the one system in the process flow; and
a second action to be performed if an error has occurred downstream of the one system in the process flow.

16. The system of claim 11, wherein for at least one system of the set of grain handling systems, the set of control parameters indicated by the process flow specifies:
a first action to be performed if an error has occurred upstream of the one system in the process flow; and
a second action to be performed if an error has occurred downstream of the one system in the process flow;
wherein for each of the at least one system of the set of grain handling systems, the set of control parameters indicated by the process flow specifies:
a first action to be performed if an error has occurred upstream of the one system in the process flow; and
a second action to be performed if an error has occurred downstream of the one system in the process flow.

17. The system of claim 11, wherein for at least one system of the set of grain handling systems, the set of control parameters indicated by the process flow specifies:
a first action to be performed if an error has occurred upstream of the one system in the process flow;
a second action to be performed if an error has occurred downstream of the one system in the process flow; and
a third action to be performed if the set of trigger conditions indicates an error occurs in the one system.

18. The system of claim 11, wherein the central control system is configured to evaluate a process flow created using the first user interface to determine if the set of control parameters are likely to cause damage to equipment, loss of grain, or harm to workers if an error occurs.

19. The system of claim 11, wherein the central control system is configured to evaluate a process flow created using the first user interface and present a warning via the first user interface if the set of control parameters are likely to cause damage to equipment, loss of grain, or harm to workers if an error occurs.

20. A method for controlling grain handling systems for a grain handling site, comprising:
providing a user interface configured to facilitate the creation of a process flow;
using the user interface creating a process flow by:
presenting a list of grain handling systems installed at the grain handling site;
selecting one or more grain handling systems to be used in the process flow from the list of grain handling systems; and
selecting a set of control parameters;
the set of control parameters including control parameters to be used when an error occurs before the grain handling systems in the process flow and control parameters to be used when an error occurs after the grain handling system in the process flow.

21. The method of claim 20, wherein the creation of the process flow further includes selecting a set of error parameters indicating conditions for detecting when the error has occurred in the process flow.

22. The method of claim 20, wherein the creation of the process flow further includes specifying a sequential order of the one or more grain handling in the process flow.

23. The method of claim 20, wherein the selected set of control parameters includes control parameters for each of the one or more grain handling systems.

24. The method of claim 20, wherein the selected set of control parameters includes for each of the one or more grain handling systems, control parameters indicating actions to be taken by the system when an error occurs upstream of the system in the process flow and control parameters indicating actions to be taken by the system when an error occurs downstream of the system in the process flow.

25. The method of claim 20, further comprising evaluating the process flow created using the user interface and presenting a warning via the user interface if the set of control parameters are likely to cause damage to equipment, loss of grain, or harm to workers if an error occurs.

26. The method of claim 20, further comprising, in response to a user input, executing the process flow by:
programming one or more intermediate control devices, which are communicatively connected to the selected one or more grain handling systems, to operate the selected one or more grain handling systems in accordance with the created process flow.

27. The method of claim 20, further comprising, in response to a user input, executing the process flow by:
programming one or more intermediate control devices, which are communicatively connected to the selected one or more grain handling systems, to operate the selected one or more grain handling systems in accordance with the created process flow; and
while operating the selected one or more grain handling systems in accordance with the created process flow:
monitoring operation of the selected one or more grain handling systems for errors, and
in response to detecting an error in one of the selected one or more grain handling systems prompting the one or more intermediate control devices to use the set of control parameters to adjust operation of selected one or more grain handling systems.
